(19) United States
(12) Patent Application Publication
(10) Pub. No.: US 2026/0347532 A1
(43) Pub. Date: Nov. 5, 2026

(54) HEAT-CURABLE POLYURETHANE COMPOSITIONS WITH WIDE TEMPERATURE WINDOW

(71) Applicant: SIKA TECHNOLOGY AG, Baar (CH)

(72) Inventors: Michael SCHLUMPF, Stallikon (CH); Melanie JENNI, Gränichen (CH)

(73) Assignee: SIKA TECHNOLOGY AG, Baar (CH)

(21) Appl. No.: 19/106,101

(22) PCT Filed: Oct. 25, 2023
(86) PCT No.: PCT/EP2023/079756

§ 371 Date: Feb. 24, 2025

(30) Foreign Application Priority Data
Oct. 26, 2022 (EP) 22203934.9

(51) Int. Cl. C08G 18/65; C08G 18/10; C08G 18/32; C08G 18/58; C08K 5/12

(52) U.S. Cl. CPC C08G 18/6529; C08G 18/10; C08G 18/3231; C08G 18/58; C08K 5/12

(57) ABSTRACT

A hydrazide having a melting point of at least 65 °C is used as curing agent for thermal curing in a heat-curable polyurethane composition including a prepolymer having isocyanate end groups that is obtained from at least one polyisocyanate and at least one polyol, and also at least one epoxy resin. This combination affords heat-curing polyurethane compositions that have better storage stability and are curable with consistent mechanical properties over a wide temperature range.

### TECHNICAL FIELD

The invention relates to use of a curing agent for thermal curing in a heat-curable polyurethane composition. The invention further relates to a heat-curable polyurethane composition and to a method for curing such a composition.

### STATE OF THE ART

Polyurethane compositions have long been known and are used in many sectors, for example as adhesives, sealants or coatings in the building and manufacturing industries. A distinction is made between one-component (1K) and two-component (2K) polyurethane (PUR) compositions. In the case of 1K polyurethane compositions, in which all constituents are present in one component, a further distinction can be made between moisture-curing compositions that cure under the influence of atmospheric moisture, and heat-curing compositions, in which curing is induced by heating.

WO 2009/080738 A1 (Sika Technology AG) describes for example a moisture-curing polyurethane composition including a polyisocyanate and an aldehyde- or ketone-blocked amine as moisture-activatable crosslinker. These compositions cure with moisture at room temperature or slightly elevated temperature, especially below 40 °C, forming aldehydes and/or ketones. In order to a markedly reduce unwanted outgassing of the aldehydes and ketones in the cured state, the composition contains hydrazides that react with the aldehydes and/or ketones at temperatures above 80 °C to form nonvolatile components. Heat-curing polyurethane compositions are used primarily as adhesives and sealants in industrial manufacturing. They are used in particular as sealants in motor vehicle construction, where the heat-curing polyurethane compositions, for example, after the painting of the components, alongside the curing of the paint, in appropriate curing ovens, typically at temperatures of >110 °C.

In heat-curing polyurethane compositions, thermally labile curing agents or heat-activatable curing agents are used, which initiate the process of curing the composition at a defined temperature.

EP 0 255 572 A1 (Sika AG) describes for example a one-component adhesive and/or sealing compound comprising a prepolymer based on polyurethane and a heat-activatable curing agent, wherein the stoichiometric ratio between prepolymer and curing agent is chosen such that only partial crosslinking is possible when heated to temperatures of 60 to 180 °C and a product having highly viscous to plastic properties is obtained. Curing agents mentioned are dicyandiamides or the sodium chloride complex salt of 4,4′-diaminodiphenylmethane.

However, in the case of currently known heat-curable polyurethane compositions there is usually the problem that these have to be cured within a relatively narrow temperature window. If temperatures are too low, there is normally a risk that the curing agent will not undergo complete reaction, which can result in exudation of the curing agent as an oily liquid from the cured product. If the temperature is too high, there is on the other hand a risk of undesirable pronounced discolorations. Moreover, polyurethane compositions are usually not stable at high temperatures and begin to decompose at temperatures of more than 180 °C up to at the latest more than 200 °C. This is manifested in a significant loss of mechanical properties such as tensile strength.

Known heat-curable polyurethane compositions are moreover often based on problematic substances, for example 4,4′-methylenedianiline, which is classified as a substance of very high concern (SVHC) under REACH legislation, or they have insufficient storage stability.

There is therefore still a need for improved solutions in which the disadvantages mentioned are present to a lesser degree or not at all.

### SUMMARY OF THE INVENTION

It is therefore an object of the invention to provide improved solutions for heat-curable polyurethane compositions that overcome the abovementioned disadvantages and are suitable especially as a one-component adhesive and/or sealant composition. The temperature window within which the compositions can be cured should preferably be as wide as possible. This is especially so that the mechanical properties of the cured product can be reliably guaranteed essentially or at least largely independently of the curing temperature. A further aim is that the compositions show as little discoloration as possible at high curing temperatures and do not significantly lose their mechanical properties, and that the compositions are as stable as possible with respect to the separation or segregation of components. The latter particularly also in the case of a partial or incomplete heat-curing reaction, as can occur for example if the curing temperature is too low. Lastly, the compositions should also be storage-stable for as long as possible even at relatively high ambient temperatures.

It has been found that, surprisingly, the object is achieved by the use as claimed in claim 1. The core of the invention is accordingly the use of a hydrazide having a melting point of at least 65 °C as curing agent for thermal curing in a heat-curable polyurethane composition comprising a prepolymer having isocyanate end groups that is obtained from at least one polyisocyanate and at least one polyol, and also at least one epoxy resin.

It has been found that hydrazides can be used as curing agents in 1K polyurethane compositions that comprise at least one prepolymer having isocyanate end groups in combination with an epoxy resin, and result in unexpected advantages. It is thus possible to provide storage-stable 1K polyurethane compositions that are suitable as adhesives and/or sealants and can be cured in a controlled manner by heat-curing within a broad temperature window, especially within a range of 100-120 °C, and, when cured over the entire temperature range, have excellent mechanical properties and are not prone to discoloration. Said compositions are storage-stable from room temperature up to 60 °C.

It is assumed that the reason for this is that the hydrazides used as curing agents already bring about effective curing even at comparatively low curing temperatures beginning above the melting point of the hydrazide, without the epoxy resin used in parallel having an adverse effect on this process. Particularly at higher temperatures, for example above 150 °C, the epoxy resin is likely to contribute to curing by reacting with other constituents of the composition, for example the hydrazide, accompanied by crosslinking. A surprise here was that the use according to the invention of the combination of hydrazides and epoxy resin in curing at high temperatures leads in the cured products to far less pronounced discoloration and far better temperature stability of the mechanical properties than was the case in heat-curable polyurethane compositions known up to now.

In addition, compositions are obtainable that are stable to separation of the components even in the event of an incomplete thermal curing reaction, such as can occur for example when the curing temperatures are too low. In particular, it is possible to effectively avoid the problem of exudation of oily liquids from the cured product.

This may be due to the hydrazide having a relatively high melting point, which ensures that any unreacted curing agent remains in the cured product in an unreacted state. Thus, even if a certain proportion of the prepolymer in the heat-curing composition does cure through moisture before the actual thermal curing, resulting in a shift in the ratio of available prepolymer to curing agent, the excess of curing agent does not represent a problem with regard to segregation.

The discolorations common in polyurethane compositions are in the present case very low even at high curing temperatures of up to 220 °C and can in addition be avoided as far as possible by means of stabilizers, in particular phosphite stabilizers.

The polyurethane compositions obtainable according to the invention have, in particular, stable mechanical properties across the entire use range and particularly at curing temperatures up to 220 °C, especially with respect to elastic modulus.

A further advantage of the present invention is that it is possible to dispense with problematic substances, for example 4,4′-methylenedianiline, which is classified as a substance of very high concern (SVHC) under REACH legislation, and to provide unexpectedly advantageous alternatives.

In addition, the obtainable polyurethane compositions adhere very well to metal substrates and to a wide variety of coatings, in particular to coatings such as those applied in motor vehicle construction, for example by cathodic electrocoating.

The polyurethane compositions obtainable through the use according to the invention can be employed inter alia as adhesives and sealants in industrial manufacturing, especially as sealants in motor vehicle construction, where they can be cured, for example on freshly painted components, alongside the curing of the paint, in appropriate curing ovens.

Further aspects of the invention are the subject of further independent claims. Particularly preferred embodiments of the invention are the subject of the dependent claims.

### WAYS OF EXECUTING THE INVENTION

A first aspect of the present invention relates to the use of a hydrazide having a melting point of at least 65 °C in combination with an epoxy resin as curing agent for thermal curing in a heat-curable polyurethane composition comprising a prepolymer having isocyanate end groups that is obtained from at least one polyisocyanate and at least one polyol.

Compound names beginning with “poly” refer to substances containing two or more of the functional groups that occur in their name per molecule. The compounds may be monomeric, oligomeric or polymeric compounds. A polyol is, for example, a compound having two or more hydroxyl groups. A polyisocyanate is a compound having two or more isocyanate groups.

Isocyanate-reactive compounds are compounds that have at least one isocyanate-reactive group that can react with isocyanate groups to form a chemical bond.

A one-component polyurethane composition means a composition in which the constituents are present in one component. In general, a one-component composition is storage-stable for at least a certain period of time (e.g. at least 1 day or at least 1 month) at room temperature (e.g. 23 °C) and—if the system is moisture-curable—with exclusion of atmospheric moisture.

The term “storage-stable” refers to the property of a substance or composition that it can be stored at room temperature in a suitable container for a period of several weeks up to 6 months or longer without said storage resulting in any change in its application or use properties to a degree relevant to its use.

Average molecular weight here means number-average molecular weight (Mn), which can be determined by gel-permeation chromatography (GPC) against polystyrene standard.

Thermal curing is understood as meaning curing at an elevated temperature of, for example, at least 80 °C, in particular at least 100 °C, especially more than 120 °C. Thermal curing is carried out in particular at a temperature above the melting point of the hydrazide.

In the case of thermal curing, the polyurethane composition is simultaneously cured throughout after application. By contrast, in the case of moisture curing, there is diffusion-controlled curing of the polyurethane composition after application from the outside inward. Moisture curing is understood as meaning curing under moisture, especially atmospheric moisture. Moisture curing is generally carried out at a temperature of not more than 40 °C, whereas moisture curing is usually carried out at room temperature, i.e. for example at temperatures below 35 °C, for example about 23 °C.

All the details that follow, especially those relating to the polyurethane composition, to the method and to the uses, are of course also equally applicable to the use of the invention, the method of the invention, the products obtainable therefrom, and to the adhesive and/or sealant compositions of the invention, even when there is no separate reference thereto.

The polyurethane composition of the invention comprises a prepolymer having isocyanate end groups that is formed from at least one polyisocyanate and at least one polyol. It is also possible to use mixtures of two or more prepolymers of this kind. Prepolymers having isocyanate end groups are known to the person skilled in the art. The prepolymer has at least two isocyanate end groups and preferably exactly two isocyanate end groups. By means of the isocyanate end groups, the prepolymer can be chain-extended or crosslinked through reaction with compounds having isocyanate-reactive groups, for example water, hydroxyl groups or amino groups, which brings about the curing of the polyurethane composition. The terms “curing” or “crosslinking” encompass hereinafter also chain-extension reactions.

The prepolymer having isocyanate end groups that is formed from at least one polyisocyanate and at least one polyol is a polyurethane prepolymer prepared by reaction of at least one polyisocyanate and at least one polyol. A person skilled in the art is able to readily prepare such prepolymers.

The reaction of the at least one polyol with at least one polyisocyanate can be effected for example by reacting the polyol component and the polyisocyanate component by customary methods, for example at temperatures of 50 to 100 °C, optionally in the presence of a suitable catalyst and with the polyisocyanate used in a stoichiometric excess. It is optionally possible, if required, to add to the reaction mixture additives such as solvents and/or plasticizers. The reaction product formed is the prepolymer having isocyanate end groups. Any solvents used can be removed again after the reaction. Any plasticizers used are preferably able to remain in the product obtained.

The polyisocyanate for the formation of the prepolymer having isocyanate end groups is preferably a polyisocyanate, especially a diisocyanate, selected from aliphatic polyisocyanates and/or aromatic polyisocyanates. It is possible to use one such polyisocyanate or two or more such polyisocyanates. Preference is given to an aliphatic polyisocyanate.

An aliphatic polyisocyanate is an aliphatic compound having at least two isocyanate groups. Preference is given to an aliphatic diisocyanate. The aliphatic polyisocyanate may be an acyclic or cyclic aliphatic polyisocyanate, preference being given to a cyclic aliphatic polyisocyanate. Preference is given to a saturated aliphatic polyisocyanate. These polyisocyanates are known and commercially available.

Examples of a suitable aliphatic polyisocyanate are hexamethylene 1,6-diisocyanate, 2,2,4- and 2,4,4-trimethylhexamethylene 1,6-diisocyanate, dodecamethylene 1,12-diisocyanate, cyclobutane 1,3-diisocyanate, cyclohexane 1,3- and 1,4-diisocyanate and mixtures of these isomers, isophorone diisocyanate (IPDI, 1-isocyanato-3,3,5-trimethyl-5-isocyanatomethylcyclohexane), hexahydrotolylene 2,4- and 2,6-diisocyanate, hexahydrophenyl 1,3- and 1,4-diisocyanate, perhydrodiphenylmethane 2,4′- and -4,4′-diisocyanate, and mixtures of the aforementioned isocyanates. Particular preference is given to isophorone diisocyanate (IPDI) and hexamethylene 1,6-diisocyanate (HDI).

Examples of a suitable aromatic polyisocyanate are diphenylmethane 4,4′-diisocyanate, optionally containing fractions of diphenylmethane 2,4′- and/or 2,2′-diisocyanate (MDI), tolylene 2,4-diisocyanate or mixtures thereof with tolylene 2,6-diisocyanate (TDI), phenylene 1,4-diisocyanate (PDI), and/or naphthalene 1,5-diisocyanate (NDI).

The polyisocyanate is more preferably diphenylmethane 4,4′-diisocyanate, optionally containing fractions of diphenylmethane 2,4′- and/or 2,2′-diisocyanate (MDI), tolylene 2,4-diisocyanate or mixtures thereof with tolylene 2,6-diisocyanate (TDI) and/or isophorone diisocyanate (IPDI).

In order to form the prepolymer having isocyanate end groups, the at least one polyisocyanate is reacted with one or more polyols. It is possible to use any of the polyols that are customary for polyurethane chemistry. Suitable polyols are commercially available in a wide variety.

The polyol preferably has an average molecular weight or, if it is a nonpolymeric polyol, a molecular weight of 250 to 30 000 g/mol and preferably of 400 to 20 000 g/mol.

The polyol also preferably has an average OH functionality in the range from 1.6 to 3. It will be understood that polymeric compounds may also include substances formed from side reactions that have, for example, just one or no hydroxyl group.

The polyol is preferably a diol or triol having an OH value in the range from 8 to 185 mg KOH/g, especially in the range from 10 to 120 mg KOH/g.

Polyols used may for example be the following commercial polyols or mixtures thereof:
a) polyoxyalkylene polyols, also called polyether polyols or oligoetherols, that are polymerization products of ethylene oxide, 1,2-propylene oxide, 1,2- or 2,3-butylene oxide, oxetane, tetrahydrofuran or mixtures thereof, possibly polymerized with the aid of a starter molecule having two or more active hydrogen atoms, such as water, ammonia or compounds having two or more OH or NH groups, for example ethane-1,2-diol, propane-1,2- and -1,3-diol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, cyclohexane-1,3- and -1,4-dimethanol, bisphenol A, hydrogenated bisphenol A, 1,1,1-trimethylolethane, 1,1,1-trimethylolpropane, glycerol, aniline, and mixtures of the aforementioned compounds. It is possible to use either polyoxyalkylene polyols having a low degree of unsaturation (measured according to ASTM D-2849-69 and reported in milliequivalents of unsaturation per gram of polyol (meq/g)), prepared for example with the aid of what are known as double metal cyanide complex catalysts (DMC catalysts), or polyoxyalkylene polyols having a higher degree of unsaturation, for example prepared with the aid of anionic catalysts such as NaOH, KOH, CsOH or alkali metal alkoxides.
Polyoxyalkylene diols or polyoxyalkylene triols are particularly suitable, especially polyoxyethylene di- and triols and polyoxypropylene di- and triols. Polyoxyalkylene diols and triols having a degree of unsaturation of less than 0.02 meq/g and having an average molecular weight in the range from 1000 to 30 000 g/mol are especially suitable, as are polyoxypropylene diols and triols having an average molecular weight of 400 to 8000 g/mol.
Likewise particularly suitable are so-called ethylene oxide-terminated (“EO-endcapped”, ethylene oxide-endcapped) polyoxypropylene polyols. The latter are special polyoxypropylene polyoxyethylene polyols that are obtained for example when pure polyoxypropylene polyols, especially polyoxypropylene diols and triols, are after the end of the polypropoxylation reaction further alkoxylated with ethylene oxide and thus have primary hydroxyl groups.
b) Styrene-acrylonitrile-grafted or acrylonitrile-methyl methacrylate-grafted polyether polyols.
c) Polyester polyols, also called oligoesterols, prepared by known methods, especially the polycondensation of hydroxycarboxylic acids or the polycondensation of aliphatic and/or aromatic polycarboxylic acids with di- or polyhydric alcohols.
Especially suitable polyester polyols are those that are prepared from di- to trihydric, especially dihydric, alcohols, for example ethylene glycol, diethylene glycol, propylene glycol, dipropylene glycol, neopentyl glycol, butane-1,4-diol, pentane-1,5-diol, 3-methylhexane-1,5-diol, hexane-1,6-diol, octane-1,8-diol, decane-1,10-diol, dodecane-1,12-diol, 1,12-hydroxystearyl alcohol, 1,4-cyclohexanedimethanol, dimer fatty acid diol (dimer diol), neopentyl glycol hydroxypivalate, glycerol, 1,1,1-trimethylolpropane or mixtures of the aforementioned alcohols, with organic di- or tricarboxylic acids, especially dicarboxylic acids, or anhydrides or esters thereof, for example succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride, or mixtures of the aforementioned acids, and also polyester polyols formed from lactones, for example from F-caprolactone and starters such as the aforementioned di- or trihydric alcohols.
d) Polycarbonate polyols as obtainable for example through reaction of the abovementioned alcohols—used to form the polyester polyols—with dialkyl carbonates, diaryl carbonates or phosgene.
e) Block copolymers bearing at least two hydroxyl groups and having at least two different blocks having polyether, polyester and/or polycarbonate structure of the type described above, especially polyether polyester polyols.
f) Polyacrylate polyols and polymethacrylate polyols.
g) Polyhydroxy-functional fats and oils, for example natural fats and oils, especially castor oil; or polyols obtained by chemical modification of natural fats and oils—called oleochemical polyols—for example the epoxy polyesters or epoxy polyethers obtained by epoxidation of unsaturated oils and subsequent ring opening with carboxylic acids or alcohols, or polyols obtained by hydroformylation and hydrogenation of unsaturated oils; or polyols obtained from natural fats and oils by degradation processes such as alcoholysis or ozonolysis and subsequent chemical linkage, for example by transesterification or dimerization, of the degradation products or derivatives thereof thus obtained. Suitable breakdown products of natural fats and oils are in particular fatty acids and fatty alcohols and also fatty acid esters, in particular the methyl esters (FAME), which can be derivatized to hydroxy fatty acid esters, for example by hydroformylation and hydrogenation.
h) Polyhydrocarbon polyols, also called oligohydrocarbonols, for example polyhydroxy-functional polyolefins, polyisobutylenes, polyisoprenes; polyhydroxy-functional ethylene/propylene, ethylene/butylene or ethylene/propylene/diene copolymers; polyhydroxy-functional polymers of dienes, especially of 1,3-butadiene, which can especially also be prepared from anionic polymerization; polyhydroxy-functional copolymers of dienes, such as 1,3-butadiene, or diene mixtures and vinyl monomers, such as styrene, acrylonitrile, vinyl chloride, vinyl acetate, vinyl alcohol, isobutylene and isoprene, for example polyhydroxy-functional acrylonitrile/butadiene copolymers, as can be prepared, for example, from epoxides or aminoalcohols and carboxyl-terminated acrylonitrile/butadiene copolymers; and hydrogenated polyhydroxy-functional polymers or copolymers of dienes.

The NCO/OH ratio in the reaction between polyisocyanate and the polyol is preferably in the range from 2/1 to 10/1, more preferably in the range from 3/1 to 8/1, especially in the range from 4/1 to 7/1.

The prepolymer preferably has an NCO content in the range from 0.5% to 10% by weight, preferably 0.6% to 8.4% by weight, especially 0.8% to 7% by weight.

In particular, the prepolymer having isocyanate end groups that is formed from at least one polyisocyanate and at least one polyol has a content of monomeric polyisocyanates, especially monomeric diisocyanates, of not more than 0.5% by weight, preferably not more than 0.3% by weight, in particular not more than 0.2% by weight, especially not more than 0.1% by weight.

Prepolymers used are preferably those that are formed with isophorone diisocyanate (IPDI) and/or diphenylmethane 2,2′-diisocyanate (MDI); where the prepolymer has a content of monomeric polyisocyanates, especially monomeric diisocyanates, of not more than 0.5% by weight, preferably not more than 0.3% by weight, in particular not more than 0.2% by weight, especially not more than 0.1% by weight.

Such a prepolymer is particularly suitable for the production of formulations such as, in particular, elastic adhesives, sealants and coatings that have a content of monomeric polyisocyanates, especially monomeric diisocyanates, of less than 0.1% by weight; these can be safely handled even without special safety precautions and can thus be sold in many countries without hazard labeling.

It has additionally been found that prepolymers having a low proportion of monomeric polyisocyanates, when used together with the curing agents used in accordance with the invention, result in particularly advantageous polyurethane compositions in which the advantages of the invention are manifested to a particular degree. Particularly in the case of MDI-based prepolymers, it is advantageous to remove the excess MDI monomers after preparation, since these can otherwise influence the curing of the polymer containing isocyanate groups with the hydrazide by slowing this down, particularly in embodiments in which the hydrazide has already been coated with MDI, as described further below. However, in the case of IPDI- or TDI-based prepolymers, the presence of residual monomeric diisocyanates has no influence on curing.

The reaction between the polyisocyanate and the polyol is preferably carried out with exclusion of moisture at a temperature in the range from 20 to 160 °C, especially 40 to 140 °C, optionally in the presence of suitable catalysts.

After the reaction, the monomeric polyisocyanate remaining in the reaction mixture, in particular the remaining monomeric diisocyanate, can be removed by means of a suitable separation method down to the residual content described.

Preference as the method of separation is given to a distillative method, especially thin-film distillation or short-path distillation, preferably with application of reduced pressure.

Particular preference is given to a multistage method in which the monomeric polyisocyanate or diisocyanate is removed in a short-path evaporator with a jacket temperature in the range from 120 to 200 °C and a pressure of 0.001 to 0.5 mbar.

In the case of IPDI, which is the preferred monomeric diisocyanate, the jacket temperature is preferably in the range from 140 to 180 °C.

Preference is given to reacting the monomeric polyisocyanate, in particular the monomeric diisocyanate, and the polyol and subsequently removing the monomeric polyisocyanate remaining in the reaction mixture without use of solvents and/or entraining agents.

Preferably, the monomeric polyisocyanate removed after the reaction is subsequently reused, i.e. used again for the preparation of polymer containing isocyanate groups.

In the reaction, the OH groups of the polyol react with the isocyanate groups of the monomeric polyisocyanate, in particular the monomeric diisocyanate. This results also in what are known as chain-extension reactions, in which OH groups and/or isocyanate groups of products of the reaction between polyol and monomeric polyisocyanate undergo reaction. The higher the chosen NCO/OH ratio, the lower the level of chain-extension reactions that takes place, and the lower the polydispersity and hence the viscosity of the polymer obtained. A measure of the chain-extension reaction is the average molecular weight of the polymer or the peak width and peak distribution in the GPC analysis. A further measure is the effective NCO content of the polymer after being freed of monomers relative to the theoretical NCO content calculated from the reaction of every OH group with a monomeric polyisocyanate.

The polymer containing isocyanate groups and having a low monomeric polyisocyanate content preferably has a viscosity at 20 °C of not more than 50 Pa·s, especially not more than 40 Pa·s, more preferably not more than Pa·s. The viscosity is determined here with a cone-plate viscometer having a cone diameter of 25 mm, cone angle of 1°, and cone tip-plate distance of 0.05 mm, and at a shear rate of 10 s⁻¹.

The preferred polymers or prepolymers containing isocyanate groups can be used to obtain high-quality, easily processible heat-curing and polyurethane compositions.

A particularly preferred polymer having a low monomeric polyisocyanate content has an NCO content in the range from 1% to 2.5% by weight, preferably 1.1% to 2.1% by weight, based on all repeat units in the polyether segment, 80% to 100% by weight, especially 80% to 90% by weight, of 1,2-propyleneoxy groups and 0% to 20% by weight, especially 10% to 20% by weight, of 1,2-ethyleneoxy groups and a monomeric polyisocyanate content of not more than 0.3% by weight, and is obtained from the reaction of IPDI with a polyether triol having an average OH functionality in the range from 2.2 to 3, preferably 2.2 to 2.8, especially 2.2 to 2.6, and an OH value in the range from 10 to 42 mg KOH/g, especially 20 to 35 mg KOH/g.

A further particularly preferred prepolymer having a low monomeric polyisocyanate content has an NCO content in the range from 2.8% to 7% by weight, based on all repeat units in the polyether segment, 100% propyleneoxy groups and a monomeric polyisocyanate content of not more than 0.3% by weight, and is obtained from the reaction of IPDI with at least one polyether diol having an OH value in the range from 44 to 120 mg KOH/g.

The proportion in the polyurethane composition of prepolymer having isocyanate end groups that is formed from at least one polyisocyanate and at least one polyol may for example be in the range from 10% to 90% by weight, especially from 15-70% by weight, preferably 20-50% by weight, in particular 25-45% by weight.

In the present case, a hydrazide in combination with the epoxy resin is used specifically as a curing agent.

Hydrazides are of a class of compounds having a functional group in which two nitrogen atoms are joined via a covalent bond. In particular, the hydrazides are in the present context organic hydrazides. These are typically derivatives of organic acids, for example carboxylic acids and/or sulfonic acids. Carbonyl hydrazides bear as substituent, aside from at least one hydrazide group, at least one acyl group, whereas sulfonyl hydrazides bear as substituent, aside from at least one hydrazide group, at least one sulfonyl group.

The hydrazide used is especially in particulate form, preferably pulverulent form. In an advantageous embodiment, the hydrazide is in powder form with a D50 particle size value of ≤50 μm, especially ≤20 μm, preferably ≤10 μm, more preferably ≤7.5 μm, most preferably ≤5 μm The D50 particle size refers to the value at which 50% by weight of the particles have a size less than or equal to the value stated. The D50 particle size can typically be determined by laser light scattering in accordance with standard ISO 13320:2020, for example with the CILAS 920 instrument from CILAS.

In the use according to the invention, the hydrazide is mixed with the prepolymer, preferably in such a way that the hydrazide is distributed uniformly in the prepolymer. In particular, the prepolymer prior to curing forms a continuous phase with the particulate hydrazide dispersed therein.

The hydrazide is preferably used in a proportion of 1.5-10 parts by weight, preferably 2.0-7.5 parts by weight, especially 2.5-5.5 parts by weight, based on one part by weight of isocyanate groups in the prepolymer present in the heat-curable polyurethane composition. This means, for example, that if using 100 grams of a prepolymer having an NCO content of 2% by weight, preferably between 3 and 20 grams of hydrazide are used.

The hydrazide is preferably used in a proportion of 0.5-15% by weight, preferably 1-10% by weight, especially 1.5-23.0% by weight, based on the total weight of the heat-curable polyurethane composition.

In a preferred embodiment, the hydrazide is coated with an isocyanate monomer, in particular with a diisocyanate monomer, especially with diphenylmethane diisocyanate monomer. In particular, the isocyanate monomer is diphenylmethane 4,4′-diisocyanate, optionally containing proportions of diphenylmethane 2,4′- and/or 2,2′ diisocyanate. The coating of the isocyanate monomer results in particular in encapsulation of the hydrazide. The isocyanate monomer allows the activation temperature and storage stability of the polyurethane compositions to be controlled, in particular increased.

When used, the isocyanate monomer used for coating is in particular chemically bound to the hydrazide. Accordingly, it is not free isocyanate monomer. Coating can be effected for example by mixing the hydrazide with the isocyanate monomer. This especially before mixing with the other components of the heat-curable polyurethane composition.

The isocyanate monomer preferably has a proportion of 0.01-1% by weight, preferably 0.02-1% by weight, especially 0.1-0.3% by weight, based on the total weight of the heat-curable polyurethane composition.

The weight ratio of isocyanate monomer to hydrazide is preferably in the range of 0.01-0.20, in particular 0.03-0.15, especially 0.05-0.12.

These proportions and ratios have proven particularly advantageous in order to control the activation temperature and storage stability of the polyurethane compositions within the ranges of industrial relevance.

It is however also possible to dispense with isocyanate monomers. In this case, the hydrazide is preferably in direct contact with the prepolymer in the polyurethane composition. Accordingly, the hydrazide is in this case in free and/or unencapsulated form. Direct contact between hydrazide and prepolymer has the advantage that thermal curing can be activated directly with the liquefaction of hydrazide, which enables controlled and rapid curing.

More preferably, the hydrazide has a melting point of at least 75 °C, preferably at least 100 °C, especially at least 110 °C, in particular at least 120 °C, more preferably at least 150 °C. It is thus possible to achieve particularly high storage stabilities and at the same time effectively reduce segregation in the event of only partial conversion of the curing agent.

In a particularly preferred embodiment, the hydrazide comprises a dihydrazide or consists thereof.

The hydrazide is preferably a hydrazide of a carboxylic acid and/or a sulfonic acid. In particular, it is a hydrazide of the formula (Ia) or (Ib) or (Ic):

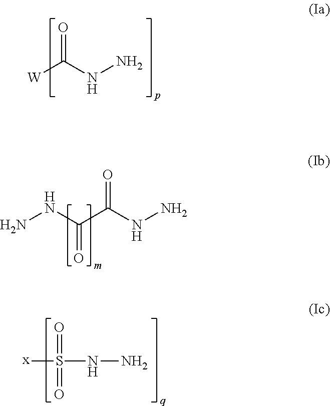

where:
W is the p-valent radical of a carboxylic acid after removal of p carboxylic acid groups;
X is the q-valent radical of a sulfonic acid after removal of q sulfonic acid groups;
mis or 1;
p is 1, 2, 3 or 4, preferably 2; and
q is 1, 2, 3 or 4.

In particular, the hydrazide is a carbonyl hydrazide, especially a carbonyl dihydrazide, preferably selected from the group consisting of carbodihydrazide, oxalic dihydrazide, succinic dihydrazide, adipic dihydrazide, suberic dihydrazide, azelaic dihydrazide, sebacic dihydrazide, dodecanedioic dihydrazide, and isophthalic dihydrazide, most preferably adipic dihydrazide.

With such hydrazides, which are commercially available from various suppliers, it is possible to produce inter alia polyurethane compositions with use ranges within broad temperature windows.

Suitable and preferred commercially available hydrazides are for example Ajicure® VDH (from Venture Chemical Ltd.) and Technicure® ADH (from A&C Catalysts).

It is further preferable when the polyurethane composition is free of aldehyde- and/or ketone-blocked amines. In particular, the polyurethane composition is free of aldimines, ketimines, enamines and/or oxazolidines. This can in particular reduce the risk of undesirable outgassing of aldehydes and/or ketones.

Suitable epoxy resins are standard industrial epoxy resins. These are obtained in a known manner, for example from the oxidation of the corresponding olefins or from the reaction of epichlorohydrin with the corresponding polyols, polyphenols or amines.

In particular, the epoxy resin is a polyepoxide.

Particularly suitable epoxy resins are what are known as liquid polyepoxide resins, hereinafter referred to as “liquid resin”. These have a glass transition temperature below 25 °C. Likewise possible as epoxy resin are what are known as solid resins, which have a glass transition temperature above 25 °C and can be comminuted to powders that are pourable at 25 °C. Liquid epoxy resins are however preferred.

Suitable epoxy resins are in particular epoxy resins of the formula (I):

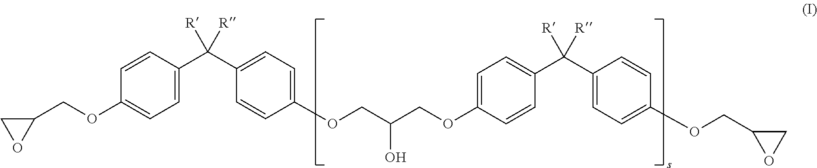

where the substituents R′ and R″ are each independently either H or CH₃. The index s has a value of from 0 to 20.

Compounds of the formula (I) having an index s of >1.5, especially of from 2 to 12, are referred to as solid epoxy resins. Such solid epoxy resins are commercially available, for example from Dow Chemical or Huntsman or Hexion.

Compounds of the formula (I) having an index s of between 1 and 1.5 are referred to by a person skilled in the art as semisolid epoxy resins. In the case of the present invention, they are likewise regarded as solid epoxy resins. The term “solid epoxy resin” is very well known to a person skilled in the art of epoxys and is used in contrast to “liquid epoxy resins”.

Compounds of the formula (I) having an index s of between 0 to 1 are liquid epoxy resins. Preferably, s has a value of less than 0.2 here.

Suitable epoxy resins are especially aromatic epoxy resins, especially the glycidylation products of:
bisphenol A, bisphenol F or bisphenol A/F, where A stands for acetone and F for formaldehyde used as reactants in the preparation of these bisphenols. In the case of bisphenol F, positional isomers may also be present, especially ones derived from 2,4′- or 2,2′-hydroxyphenylmethane;
dihydroxybenzene derivatives such as resorcinol, hydroquinone or catechol;
further bisphenols or polyphenols such as bis(4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyl)-2-propyl]benzene (bisphenol P), 1,3-bis[2-(4-hydroxyphenyl)-2-propyl]benzene (bisphenol M), 4,4′-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl) ether or bis(4-hydroxyphenyl) sulfone;
condensation products of phenols with formaldehyde that are obtained under acidic conditions, such as phenol novolaks or cresol novolaks, also termed bisphenol F novolaks;
aromatic amines such as aniline, toluidine, 4-aminophenol, 4,4′-methylenediphenyldiamine, 4,4′-methylenediphenyldi(N-methyl)amine, 4,4′-[1,4-phenylenebis(1-methylethylidene)]bisaniline (bisaniline P) or 4,4′-[1,3-phenylenebis(1-methylethylidene)]bisaniline (bisaniline M).

Further suitable epoxy resins are aliphatic or cycloaliphatic polyepoxides, especially
glycidyl ethers of saturated or unsaturated, branched or unbranched, cyclic or open-chain di-, tri- or tetrafunctional C₂ to C₃₀ alcohols, especially ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
a hydrogenated liquid bisphenol A, F or A/F resin, or the glycidylation products of hydrogenated bisphenol A, F or A/F;
an N-glycidyl derivative of amides or heterocyclic nitrogen bases, such as triglycidyl cyanurate or triglycidyl isocyanurate, or reaction products of epichlorohydrin with hydantoin;
epoxy resins from the oxidation of olefins such as in particular vinylcyclohexene, dicyclopentadiene, cyclohexadiene, cyclododecadiene, cyclododecatriene, isoprene, 1,5-hexadiene, butadiene, polybutadiene or divinylbenzene.

Preference as epoxy resin is given to a liquid resin, especially a liquid resin based on a bisphenol.

The epoxy resin is most preferably a liquid resin based on a bisphenol A diglycidyl ether, bisphenol F diglycidyl ether or bisphenol A/F diglycidyl ether. Such liquid resins are commercially available, for example from Dow, Huntsman or Momentive. These epoxy resins have readily manageable viscosity and permit high strengths and resistances. Such liquid resins may also include proportions of solid bisphenol A resin or phenol novolaks.

An epoxy equivalent weight (EEW) of the epoxy resin is especially 100 to 500 g/eq, in particular 130 to 250 g/eq. The epoxy equivalent weight is here measured in particular according to the standard ASTM D1652-11(2019).

Such epoxy resins react at relatively high temperatures, for example 150 °C and higher, this resulting in further crosslinking of the polyurethane composition.

The epoxy resin is in particular used in a proportion of 0.1-15% by weight, preferably 1-10% by weight, especially 1.5-5% by weight, most preferably 2-4% by weight, based on the total weight of the heat-curable polyurethane composition.

In particular, no epoxide-amine adduct is used in the polyurethane composition, especially no epoxide-amine adduct obtainable by reacting a bisphenol diglycidyl ether with an aliphatic polyamine is used and/or the polyurethane composition does not contain such an epoxide-amine adduct. The aliphatic polyamine is in this case in particular a diamine, especially a diamine having one primary amine group and one secondary amine group and/or a diamine having one primary amine group and one tertiary amine group. The epoxide-amine adduct that is not used is especially an adduct as described in EP 0 365 984 A2, on page 5, lines 8-16. Such adducts are not suitable for the composition according to the present invention.

The polyurethane composition of the invention may optionally also contain one or more further auxiliaries and additives customarily used in the polyurethane industry as additives.

Examples of such additives are plasticizers; solvents; inorganic and organic fillers, for example ground or precipitated calcium carbonates, carbon blacks, kaolins, aluminas, silicas and/or PVC powders; fibers, for example of polyethylene; pigments; rheology modifiers, for example thixotropic agents, thickeners such as urea compounds, polyamide waxes, bentonites or fumed silicas; adhesion promoters, especially silanes, such as epoxysilanes, vinylsilanes and isocyanatosilanes; desiccants, for example p-tosyl isocyanate and other reactive isocyanates, orthoformic esters, calcium oxide or molecular sieves; stabilizers against heat, light and UV radiation; flame-retardant substances; surface-active substances, for example wetting agents, leveling agents, deaerating agents or defoamers; and fungicides or substances that inhibit fungal growth.

The additives may, if required and depending on the end use, be added in suitable amounts in a customary manner. In general, it is preferable that the polyurethane composition contains at least one plasticizer and/or at least one filler.

The plasticizer is for example selected from carboxylic esters such as phthalates, especially diisononyl phthalate (DINP), diisodecyl phthalate (DIDP) and/or di(2-propylheptyl) phthalate (DPHP); hydrogenated phthalates, especially hydrogenated diisononyl phthalate (DINCH); terephthalates, especially dioctyl terephthalate; trimellitates, especially trioctyl trimellitate; adipates, especially dioctyl adipate; azelates; sebacates; polyols, especially polyoxyalkylene polyols and/or polyester polyols; benzoates; glycol ethers; glycol esters; organic phosphoric, phosphonic and/or sulfonic esters; polybutenes, polyisobutenes; and/or plasticizers derived from natural fats or oils, especially epoxidized soybean oil and/or linseed oil;

The plasticizer preferably has a vapor pressure at 20 °C of less than 0.1 mbar and/or the plasticizer has a boiling point at standard pressure of 101 325 kPa of at least 250 °C, preferably at least 300 °C, especially at least 350 °C. This can in particular prevent the plasticizers from outgassing too much at higher curing temperatures, for example at 180 °C and above.

The plasticizer is particularly preferably selected from phthalates and/or trimellitates, in particular diisodecyl phthalate (DIDP) and/or trioctyl trimellitate. These have proven particularly advantageous for the present heat-curable polyurethane composition.

The plasticizer is preferably used in a proportion of 0.1-30% by weight, preferably 5-25% by weight, especially 10-20% by weight, based on the total weight of the heat-curable polyurethane composition.

Further preferably, the heat-curable polyurethane composition comprises one or more stabilizers against heat, oxygen, moisture, light and/or UV radiation. Suitable stabilizers are for example hindered amines (HALS stabilizers), hindered phenols, phosphites and/or aromatic amines. Such stabilizers are commercially available for example under the Irganox, Kinox, Dovernox, Weston, Irgaphos, Doverphos and/or lonol product names.

Phosphites, in particular organophosphites, are especially preferred as stabilizers. Organophosphites, also referred to as phosphite esters, have in particular one or more groups of the formula (II):

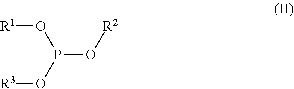

where R¹, R², and R³ are each independently an organic radical, for example a radical having 1-25 carbon atoms. The organic radicals may include one or more heteroatoms or consist exclusively of carbon and hydrogen atoms.

Preferably, at least one of the radicals R¹, R², and R³ includes an aromatic group.

In particular, the stabilizer is an organodiphosphite that includes has two groups of the formula II.

Such phosphite stabilizers are commercially available for example under the Doverphos® name.

It has surprisingly been found that phosphites make it possible to further reduce any discoloration of polyurethane compositions, which in the present case is typically very minor even at curing temperatures of 200 °C and above. In contrast, stabilizers in the form of phenols are less suitable for stabilization at such high curing temperatures.

The proportions of the constituents in the polyurethane composition may vary within wide ranges depending on the constituents used and the end use. The amounts stated below for appropriate and preferred embodiments relate to the total weight of the polyurethane composition.

More preferably, the heat-curable polyurethane composition includes the following components, based on the total weight of the heat-curable polyurethane composition:
a) 0.5-15% by weight, preferably 1-10% by weight, especially 1.5-3.0% by weight, of the hydrazide;
b) 0.1-15% by weight, preferably 1-10% by weight, especially 2-5% by weight, of the epoxy resin;
c) 15-70% by weight, preferably 20-50% by weight, especially 25-40% by weight, of the prepolymer;
d) 0-1% by weight, preferably 0.02-1% by weight, especially 0.1-0.3% by weight, of the isocyanate monomer;
e) 0-70% by weight, preferably 10-60% by weight, especially 40-50% by weight, of inorganic and/or organic fillers, in particular as described above;
f) 0-30% by weight, preferably 5-25% by weight, especially 10-20% by weight, of plasticizers, in particular as described above;
g) 0-5% by weight, preferably 0.5-4% by weight, especially 1-3% by weight, of stabilizers, in particular as described above, preferably phosphites;
h) 0-1% by weight, preferably 0.01-0.8% by weight, especially 0.05-0.6% by weight, of catalysts;
i) optionally one or more additional additives, the proportions thereof make this up to 100% by weight.

The prepolymer and the employed further components of the composition may be mixed with one another in any sequence in order to obtain the polyurethane composition. It is also possible for some components, for example the hydrazide, which is optionally coated with the isocyanate monomer, to be added for example as a mixture with a plasticizer. The mixing can be carried out at room temperature (e.g. 23 °C). It may also be carried out partly or entirely at slightly elevated temperature, for example for easier homogenization or dispersion. Mixing devices used may be any of the mixing devices known in this field. The viscosity may be set as desired, taking account of the intended use; for example, the polyurethane composition may be pasty and may preferably have structurally viscous properties.

The invention also relates to a heat-curable polyurethane composition as obtained in the use according to the invention.

In other words, it is a heat-curable polyurethane composition comprising: (i) a prepolymer having isocyanate end groups that is formed from at least one polyisocyanate and at least one polyol, (ii) a hydrazide, and (iii) an epoxy resin. Optionally, one or more of the further components described above may additionally be present.

All the above details and elucidations relating to the use according to the invention and to the heat-curable polyurethane composition, for example with regard to suitable components etc., apply mutatis mutandis.

The heat-curable polyurethane composition may be a multicomponent, e.g. two-component, heat-curable polyurethane composition. However, it is preferably a one-component heat-curable polyurethane composition.

The polyurethane composition, preferably the one-component polyurethane composition, is generally suitable for the bonding of one or more materials of the same or different characteristics and especially for bonding in motor vehicle construction or motor vehicle repair. The polyurethane composition is likewise suitable as sealant for the sealing of an element, especially for sealing in motor vehicle construction or motor vehicle repair. The element is, for example, a substrate, a surface, a join and/or a cavity.

The invention also relates to a method for curing a polyurethane composition as described above, wherein the polyurethane composition is cured by the action of heat.

The temperature used for thermal curing may vary within wide ranges depending on the polyurethane composition used, the desired degree of crosslinking, and the duration of thermal curing. The thermal curing can be carried out for example at temperatures in the range from 100 to 220 °C. The duration of thermal curing may for example be in the range from 1 to 120 min.

The invention also relates to a method for bonding adherends, especially vehicle parts, with the heat-curable polyurethane composition of the invention as described above, comprising:
a) the applying of the heat-curable polyurethane composition to the surfaces of one or both adherends to be bonded,
b) contacting of the adherend surfaces to be bonded and
c) curing of the polyurethane composition by thermal curing, especially at temperatures as described above.

The invention further relates to a method for sealing an element to be sealed with the heat-curable polyurethane composition of the invention as described above, comprising:
a) the applying of the heat-curable polyurethane composition to and/or into the element to be sealed;
b) curing of the polyurethane composition by thermal curing, especially at temperatures as described above.

The element to be sealed is especially a substrate, a surface, a join and/or a cavity, especially in a vehicle. In step a), the heat-curable polyurethane composition may be applied correspondingly to the substrate or the surface and/or introduced into the join and/or into the cavity.

The adherends, or the adherend surfaces to be bonded and or the element to be sealed, may be made of any desired material and the adherend surfaces to be bonded may be made of the same material or of different materials. Examples of suitable materials are metal, metal alloys, glass, plastic, ceramic, textiles or painted elements or adherends.

The heat-curable polyurethane composition can be applied to one or both adherend surfaces to be bonded or to the element to be sealed in a customary manner known to the person skilled in the art. Adherend surfaces to be bonded are contacted, optionally while pressing the adherend surfaces to be bonded onto one another.

The curing of the polyurethane composition is then carried out with heat, for example at temperatures in the range from 100 to 220 °C, especially in the temperature range of between 150 °C and 220 °C, by thermal curing.

The invention also relates to an article comprising adherends and to a cured polyurethane composition as a bonded combination of the adherends that is obtainable by the method of the invention. The adherends are, in particular, constituents of a vehicle.

The invention likewise relates to an element, especially of a vehicle, comprising a cured polyurethane composition as described above as sealant.

The invention is further elucidated hereinafter by way of examples, which are not however intended to restrict the invention in any way.

### EXAMPLES

Working examples are adduced hereinafter, which are intended to further elucidate the invention described. The invention is of course not limited to these described working examples.

Unless otherwise stated, the chemicals used were obtained from Sigma-Aldrich (Switzerland).

### Preparation of Prepolymers:

### Polymer P1:

780.0 g of Desmophen® 5031 BT (glycerol-started ethylene oxide-terminated polyoxypropylene triol, OH value 28.0 mg KOH/g, OH functionality approx. 2.3; from Covestro) and 220 g of 1-isocyanato-3,3,5-trimethyl-5-isocyanatomethylcyclohexane (Vestanat® IPDI, from Evonik) were converted by a known method at 80 °C into a polyetherurethane polymer having an NCO content of 6.4% by weight, a viscosity of 4.1 Pa·s at 20 °C, and a monomeric IPDI content of about 12% by weight.

The volatile constituents, in particular the major part of the monomeric IPDI, were then removed by distillation in a short-path evaporator (jacket temperature 160 °C, pressure 0.1 to 0.005 mbar). The polyetherurethane polymer thus obtained had an NCO content of 1.9% by weight, a viscosity of 8.2 Pa·s at 20 °C, and a monomeric IPDI content of 0.02% by weight.

Polymer P1 is a prepolymer (polymer containing isocyanate groups) having a low monomeric diisocyanate content.

Viscosity was measured using a thermostated Rheotec RC30 cone-plate viscometer (cone diameter 25 mm, cone angle 1°, cone tip-plate distance 0.05 mm, shear rate 10 s⁻¹).

Monomeric diisocyanate content was determined by HPLC (detection via photodiode array; 0.04 M sodium acetate/acetonitrile as mobile phase) after prior derivatization using N-propyl-4-nitrobenzylamine.

### Polyurethane Compositions

The ingredients specified in Table 1 in the amounts specified (in parts by weight) were mixed using a planetary mixer under reduced pressure and with exclusion of moisture to give one-component polyurethane compositions R and C1-C5, and stored with exclusion of moisture until use.

TABLE 1
Polyurethane compositions (numerical values in parts by weight)

| Composition → | | | | | | |
|---|---|---|---|---|---|---|
| ↓ Ingredients | R | C1 | C2 | C3 | C4 | C5 |
| Polymer P1 | 36 | 35 | 33 | 30 | 27 | 33 |
| Curing agent | | | | | | |
| Hydrazide coated with | 1.27^{1a} | 1.28 | 1.73 | 2.18 | 2.57 | 1.73 |
| isocyanate monomer¹ | 0.103^{1b} | 0.105 | 0.14 | 0.178 | 0.21 | 0.14 |
| Epoxy resin² | 0 | 1 | 3 | 6 | 9 | 3 |
| Chalk³ | 38.5 | 38.5 | 38.5 | 38.5 | 38.5 | 38.5 |
| Plasticizer^{4.5} | 14.127⁴ | 14.115⁴ | 13.63⁴ | 13.1⁴2⁴ | 12.72⁴ | 13.63⁵ |
| Rheology aid⁶ | 8.0 | 8.0 | 8.0 | 8.0 | 8.0 | 8.0 |
| Pigment⁷ | 2.0 | 2.0 | 2.0 | 2.0 | 2.0 | 2.0 |
| | 100.0 | 100.0 | 100.0 | 100.0 | 100.0 | 100.0 |

¹Adipic dihydrazide coated with diphenylmethane diisocyanate (Desmodur CD-L from Covestro) by prior mixing of the two components at 23 °C and stirring for 10 min under reduced pressure
^{1a}Total content of adipic dihydrazide used (before coating)
^{1b}Amount of isocyanate monomer used for coating
²Araldite GY 250 (from Huntsman)
³Omyacarb ® 5 GU (from Omya)
⁴Trioctyl trimellitate
⁵Diisodecyl phthalate
⁶Cab-O-Sil TS-720 (hydrophobic silica; Cabot Corp.)
⁷Titanium dioxide (Kronos 2220 from Kronos)

The compositions could be stored without any problem at temperatures of up to 60 °C for several months.

Experiment without Coating the Hydrazide with Isocyanate Monomer

An additional composition C6 was produced in which the hydrazide was not coated with isocyanate monomer, however. Composition C6 was formulated identically to composition C5, with the differences that 1.73% by weight of pure hydrazide (without prior treatment with isocyanate monomer) was used and 13.77% by weight of plasticizer was used to compensate for the difference in mass due to the missing isocyanate monomer. Thus, C6 differs from C5 essentially only in that the hydrazide is not coated with isocyanate monomer.

### Thermal Curing of Samples and Properties

Films of compositions R and C1-C6 with a layer thickness of 2 mm were cured at various curing temperatures for 30 minutes and stored for 7 days under standard climatic conditions (23 °C, 50% relative humidity). An oily liquid or the like was not exuded by the cured products either during the thermal curing process or thereafter.

The tensile strength, elongation at break, and elastic modulus were then determined according to DIN 53504 (strain rate: 200 mm/min). Table 2 gives an overview of the results.

Films with the compositions C1-C2, which comprise hydrazide as curing agent and epoxy resin, can be cured at temperatures between 100-200 °C. Tensile strength, elongation at break, and elastic modulus here remain within ranges of industrial relevance over the entire temperature range. For films with the compositions C2, C3, C4 and C5, this is the case even up to 220 °C.

In particular, the elastic modulus is relatively constant, the film with the composition C4 having a particularly stable elastic modulus over the entire temperature range and at the same time relatively high values for the tensile strength and elongation at break.

In contrast, the elastic modulus of the comparison sample R at 200 °C is only 1.5 MPa, while at 220 °C values are no longer measurable (“n.m.”).

The described working examples should however be regarded merely as illustrative examples that can be modified as desired within the scope of the invention.

TABLE 2
Properties of the polyurethane compositions

| Composition → | | | | | | | |
|---|---|---|---|---|---|---|---|
| Curing temperature/ | | | | | | | |
| ↓ properties | R | C1 | C2 | C3 | C4 | C5 | C6 |
| T = 100° | | | | | | | |
| Tensile strength [MPa] | 4.8 | 5.4 | 6.5 | 6.1 | 5.9 | — | 3.3 |
| Elongation at break [%] | 758 | 672 | 739 | 761 | 777 | — | 631 |
| Elastic modulus [MPa] | 2.4 | 3.3 | 3.0 | 2.5 | 2.0 | — | 3.1 |
| T = 120° | | | | | | | |
| Tensile strength [MPa] | 5.8 | 7.2 | 6.6 | 5.6 | 5.0 | 6.3 | 3.1 |
| Elongation at break [%] | 710 | 778 | 790 | 768 | 735 | 754 | 639 |
| Elastic modulus [MPa] | 3.4 | 3.2 | 2.6 | 2.2 | 1.8 | 2.9 | 2.7 |
| T = 140° | | | | | | | |
| Tensile strength [MPa] | 6.7 | 7.0 | 5.5 | 5.7 | 6.0 | 5.6 | — |
| Elongation at break [%] | 791 | 802 | 682 | 439 | 242 | 694 | — |
| Elastic modulus [MPa] | 3.2 | 3.1 | 2.9 | 4.2 | 5.6 | 3.2 | — |
| T = 160° | | | | | | | |
| Tensile strength [MPa] | 6.8 | 7.1 | 5.8 | 5.7 | 6.6 | 5.4 | — |
| Elongation at break [%] | 857 | 816 | 426 | 181 | 150 | 449 | — |
| Elastic modulus [MPa] | 2.8 | 2.8 | 4.5 | 6.4 | 8.5 | 4.4 | — |
| T = 180° | | | | | | | |
| Tensile strength [MPa] | 5.8 | 5.8 | 5.6 | 5.6 | 6.3 | 5.1 | — |
| Elongation at break [%] | 978 | 718 | 266 | 116 | 102 | 260 | — |
| Elastic modulus [MPa] | 2.1 | 2.6 | 4.8 | 7.0 | 9.4 | 5.1 | — |
| T = 200° | | | | | | | |
| Tensile strength [MPa] | 5.1 | 5.5 | 6.1 | 6.1 | 5.9 | 6.0 | — |
| Elongation at break [%] | 926 | 469 | 246 | 128 | 90 | 238 | — |
| Elastic modulus [MPa] | 1.5 | 1.9 | 3.9 | 6.1 | 9.1 | 3.9 | — |
| T = 220° | | | | | | | |
| Tensile strength [MPa] | n.m. | n.m. | 5.1 | 5.2 | 5.2 | 5.0 | — |
| Elongation at break [%] | n.m. | n.m. | 306 | 134 | 85 | 324 | — |
| Elastic modulus [MPa] | n.m. | n.m. | 2.3 | 4.5 | 8.1 | 2.5 | — |

The storage stability of the compositions in the container can be determined via the expression force.

For determination of the expression force, internally-coated aluminum cartridges (outer diameter 46.9 mm, inner diameter 46.2 mm, length 215 mm, opening 15-M) were filled with the compositions and sealed airtight with polyethylene stoppers (diameter 46.1 mm) from Novelis Deutschland GmbH. After conditioning at 23 °C for 24 hours, the cartridges were opened and the contents expressed by means of an expression device. For this, a nozzle having an orifice with an inner diameter of 2 mm was screwed onto the thread of the cartridge. An expression device (Zwick/Roell Z005) was used to determine the force needed to express the composition at an expression rate of 60 mm/min. The reported value is the average of the forces measured after an expression distance of 22 mm, 24 mm, 26 mm, and 28 mm. After an expression distance of 30 mm, the measurement was stopped.

To test the storage stability, cartridges were filled with compositions C5 and C6 as just described. In the fresh state, composition C5 had an expression force of 893 N. Composition C6 had an expression force of 885 N in the fresh state.

One further sealed cartridge each of composition C5 and composition C6 were stored in an oven at 60 °C for 7 days in order to simulate aging in the container. After this heated storage, the cartridges were cooled to 23 °C again for 24 h and their expression force measured again as described above. Composition C5 showed a moderate increase in expression force to 1029 N. Composition C6 on the other hand showed an expression force of 3500 N.

This shows that coating the hydrazide with isocyanate monomer significantly improves storage stability.

1. A method comprising applying a hydrazide having a melting point of at least 65 °C as curing agent for thermal curing in a heat-curable polyurethane composition comprising a prepolymer having isocyanate end groups that is obtained from at least one polyisocyanate and at least one polyol, and also at least one epoxy resin.

2. The method as claimed in claim 1, wherein the hydrazide is a carbonyl hydrazide selected from the group consisting of carbodihydrazide, oxalic dihydrazide, succinic dihydrazide, adipic dihydrazide, suberic dihydrazide, azelaic dihydrazide, sebacic dihydrazide, dodecanedioic dihydrazide, and isophthalic dihydrazide.

3. The method as claimed in claim 1, wherein the hydrazide is coated with an isocyanate monomer.

4. The method as claimed in claim 3, wherein the weight ratio of isocyanate monomer to hydrazide is in the range of 0.01-0.20.

5. The method as claimed in claim 1, wherein the hydrazide is used in a proportion of 1.5-10 parts by weight, based on one part by weight of isocyanate groups in the prepolymer present in the heat-curable polyurethane composition.

6. The method as claimed in claim 1, wherein the epoxy resin is a polyepoxide.

7. The method as claimed in claim 1, wherein the epoxy resin is used in a proportion of 0.1-15% by weight, based on the total weight of the heat-curable polyurethane composition.

8. The method as claimed in claim 1, wherein a plasticizer is additionally used.

9. The method as claimed in claim 8, wherein the plasticizer is selected from phthalates and/or trimellitates.

10. The method as claimed in claim 8, wherein the plasticizer is used in a proportion of 0.1-30% by weight, based on the total weight of the heat-curable polyurethane composition.

11. The method as claimed in claim 1, wherein the prepolymer having isocyanate end groups that is formed from at least one polyisocyanate and at least one polyol via a content of monomeric polyisocyanates, of not more than 0.5% by weight.

12. The method as claimed in claim 1, wherein the heat-curable polyurethane composition includes the following components based on the total weight of heat-curable polyurethane composition:
a) 0.5-15% by weight, of the hydrazide;
b) 0.1-15% by weight, of the epoxy resin;
c) 15-70% by weight, of the prepolymer;
d) 0-1% by weight, of the isocyanate monomer;
e) 0-70% by weight, of inorganic and/or organic fillers;
f) 0-30% by weight, of plasticizers;
g) 0-5% by weight, of stabilizers;
h) 0-1% by weight, of catalysts;
i) optionally one or more additional additives.

13. The method as claimed in claim 1, wherein the polyurethane composition is a one-component composition.

14. A heat-curable polyurethane composition, described in claim 1, comprising: (i) a prepolymer having isocyanate end groups that is formed from at least one polyisocyanate and at least one polyol, (ii) a hydrazide, and (iii) an epoxy resin.

15. A method for curing a polyurethane composition as claimed in claim 14, wherein the polyurethane composition is cured by the action of heat.
